(19) United States
(12) Patent Application Publication
(10) Pub. No.: US 2011/0023252 A1
(43) Pub. Date: Feb. 3, 2011

(54) STRUCTURE FOR DUST-COLLECTING FABRIC

(76) Inventor: Michael Kann, Taipei (TW)

Correspondence Address: Yen Jung Sung, 30-47 37 St., Astoria, NY, 11103, US

(21) Appl. No.: 12/825,333

(22) Filed: Jun. 28, 2010

(30) Foreign Application Priority Data
Aug. 3, 2009 (TW) 098214284

(51) Int. Cl. A47L 13/46; B32B 5/12; B32B 27/02; B32B 27/08

(52) U.S. Cl. 15/231; 428/112; 428/109

(57) ABSTRACT

An improved structure for a dust-collecting fabric, which is fluffy and tough, is made by overlapping plural layers of continuous filaments longitudinally and obliquely in a staggered manner. The dust-collecting fabric is not subjected to a hot pressing process, and portions of the continuous filaments are connected to each other by resin to make the whole structure fluffier. The continuous filaments are made from polyester fibers or polypropylene fibers to increase their electrostatic attractive forces. With this arrangement, the strength of the entire structure is increased and the dust-collecting capacity is improved. Furthermore, both surfaces of the duct-collecting fabric can be used.

### BACKGROUND OF THE INVENTION

1. Field of the Invention

The present invention relates to an improved structure for dust-collecting fabric, and in particular to a dust-collecting fabric which is fluffy and tough. Such a dust-collecting cloth is made by overlapping plural layers of continuous electrostatic filaments in a staggered manner. Portions of the continuous filaments are connected to each other with resin to increase the strength of the entire structure and to make the dust-collecting fabric fluffy.

2. Description of Prior Art

Since Taiwan is located in an area having an oceanic island climate, dust particles and mites are always present in the environment. Furthermore, the dust and mites present in a house may become allergens for the people living there. Therefore, various cleaning products or utensils have been proposed in order to clean such allergens in an effective and labor-saving manner.

Typically, cleaning utensils for dusting come in two categories, including handheld dust-collecting whisks and dust-collecting mops. Both the dust-collecting whisks and the dust-collecting mops are made from dust-collecting fabrics. As shown in FIG. 1a, the fabric in a conventional handheld dust-collecting whisk is made by arranging plural layers of long fiber bundles 10 in a transverse direction with respect to a handle 12, and then providing a sleeve 11 on one surface of the fiber bundles 10 for receiving the handle 12. Since the plural layers of fiber bundles 10 are arranged transversely, the fiber bundles 10 may become broken or entangled with each other when in use. Further, as shown in FIG. 1b, the fabric of another conventional dust-collecting whisk is made by arranging plural layers of short fibers 20 in a random manner, overlapping a nonwoven cloth 21 having many cutouts 210 on one surface of the short fibers 20, and providing a sleeve 22 on the nonwoven cloth 21 for receiving a handle 23. Since the short fibers 20 may detach or become broken after use over extended periods, the dust-collecting capacity of the fabric may deteriorate. On the other hand, since one surface of the conventional dust-collecting fabric is provided with the sleeve, only the one surface on which the sleeve is not provided can be used for dusting, so that both surfaces of the fabric cannot be completely used, which is a waste of the fabric.

In view of the above, the present Inventor proposes a novel dust-collecting fabric which is convenient for use, cost-effective and which has excellent dusting capabilities. In order to make such a dust-collecting fabric, plural layers of continuous filaments are overlapped longitudinally and obliquely in a staggered manner, and portions of these continuous filaments are connected to each other with a resin without using a hot pressing process, so that the finished fabric has a fluffy structure. On the other hand, such a staggered arrangement of these continuous filaments enhances the strength of the entire structure, so that the continuous filaments do not fall off easily. Since the inventive fabric is not subjected to a hot pressing process, the entire fabric is fluffier, which facilitates the collection of dust and hair. Furthermore, since no sleeve is provided on the surface of the inventive fabric, both surfaces of the inventive fabric can be used for dusting purposes. Therefore, the inventive fabric has a greater dust-collecting capacity and is more cost-effective for the user.

### SUMMARY OF THE INVENTION

A primary object of the present invention is to provide an improved structure for a dust-collecting fabric, which is made by overlapping plural layers of continuous filaments longitudinally and obliquely in a staggered manner to increase the strength and toughness thereof.

Another object of the present invention is to provide an improved structure for a dust-collecting fabric, in which portions of the overlapped continuous filaments are connected to each other with a resin, thereby making the entire fabric fluffier.

A further object of the present invention is to provide an improved structure for a dust-collecting fabric, in which the continuous filaments are made from polyester fibers or polypropylene fibers to increase electrostatic attractive forces.

A still further object of the present invention is to provide an improved structure for a dust-collecting fabric, both surfaces of which can be used.

A still further object of the present invention is to provide an improved structure for a dust-collecting fabric, in which the basic weight of the dust-collecting fabric is in a range between 60 g/m² and 300 g/m².

A still further object of the present invention is to provide an improved structure for a dust-collecting fabric, in which the thickness of the dust-collecting fabric is in a range between 0.5 cm and 6 cm.

A still further object of the present invention is to provide an improved structure for a dust-collecting fabric, in which an electrostatic plastic film is additionally provided in the dust-collecting fabric to increase electrostatic forces.

The technical contents of the present invention will be described in more detail with reference to the accompanying drawings.

### BRIEF DESCRIPTION OF THE DRAWINGS

FIG. 1a is a perspective view of a conventional dust-collecting fabric;

FIG. 1b is a perspective view of another conventional dust-collecting fabric;

FIG. 2 is an exploded perspective view of an embodiment of the present invention;

FIG. 3 is a perspective view of an embodiment of the present invention;

FIG. 4 is an exploded perspective view showing an embodiment of the dust-collecting fabric of the present invention and a handle;

FIG. 5a is a schematic view showing the handle used with the dust-collecting fabric of an embodiment of the present invention;

FIG. 5b is a view showing the rotation of an upper cover of the handle used with the dust-collecting fabric of an embodiment of the present invention;

FIG. 5c is a cross-sectional view showing the handle used with the dust-collecting fabric of an embodiment of the present invention;

FIG. 6 is a schematic view showing an embodiment of the dust-collecting fabric of an embodiment of the present invention;

FIG. 7 is a schematic view showing another embodiment of the handle used with the dust-collecting fabric of an embodiment of the present invention; and

FIG. 8 is a schematic view showing another embodiment of the dust-collecting fabric of an embodiment of the present invention.

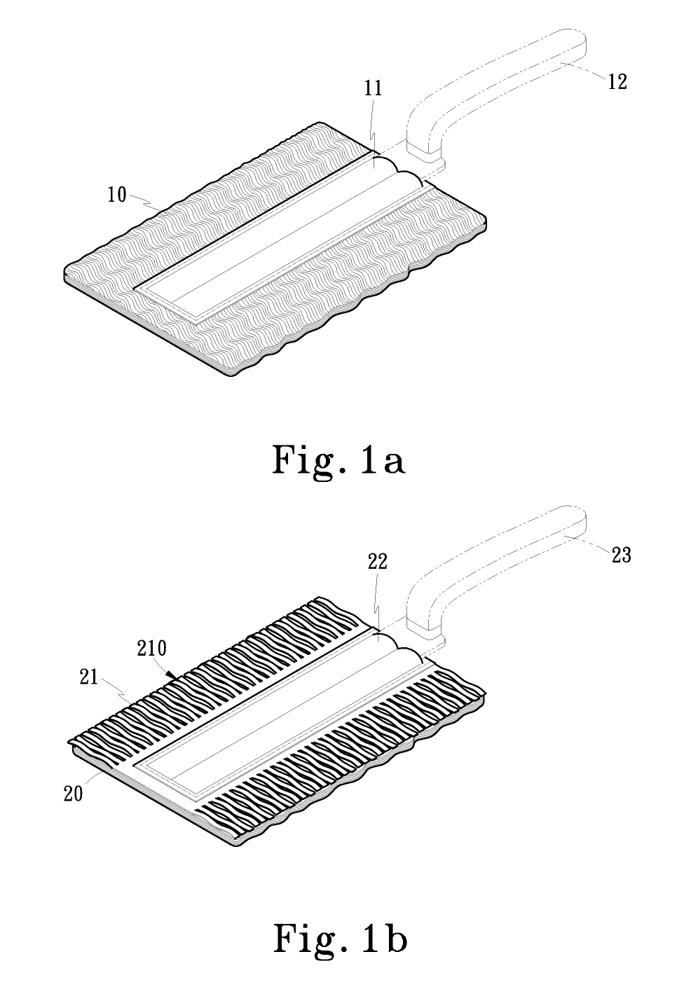

### DETAILED DESCRIPTION OF THE INVENTION

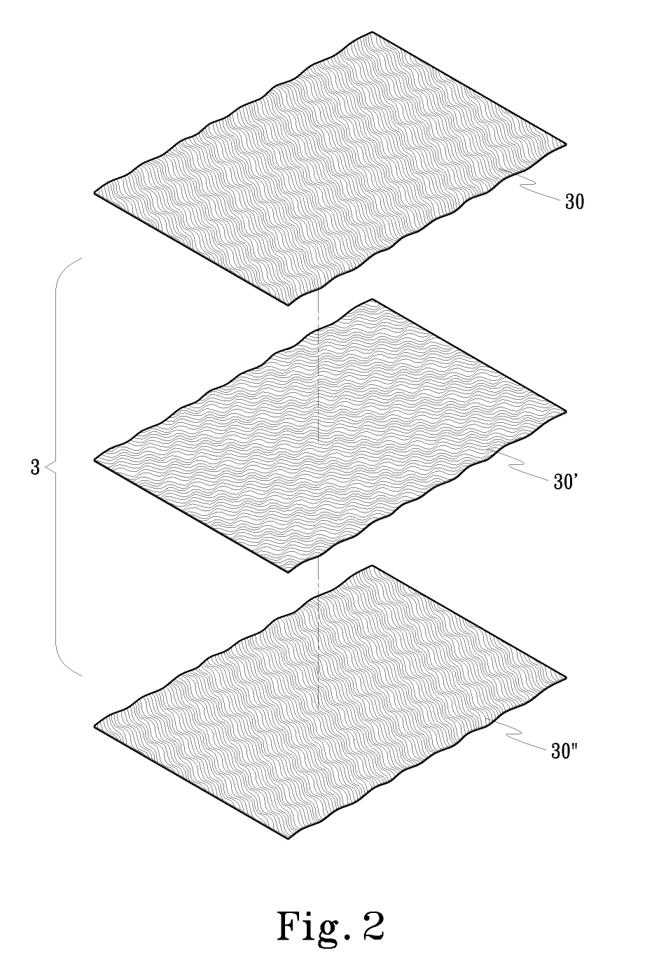

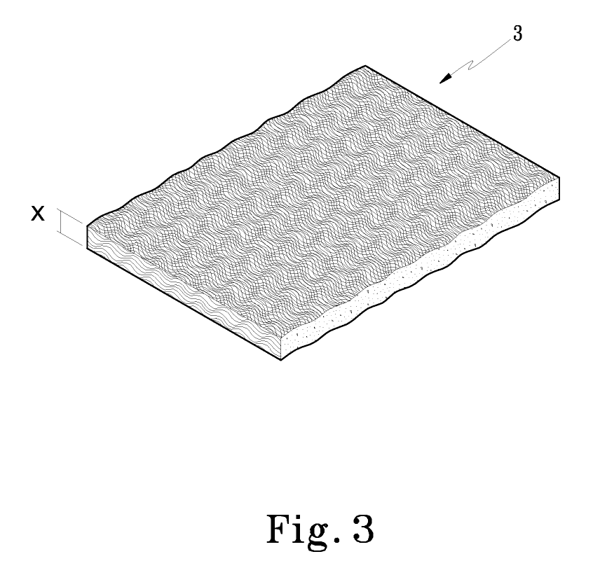

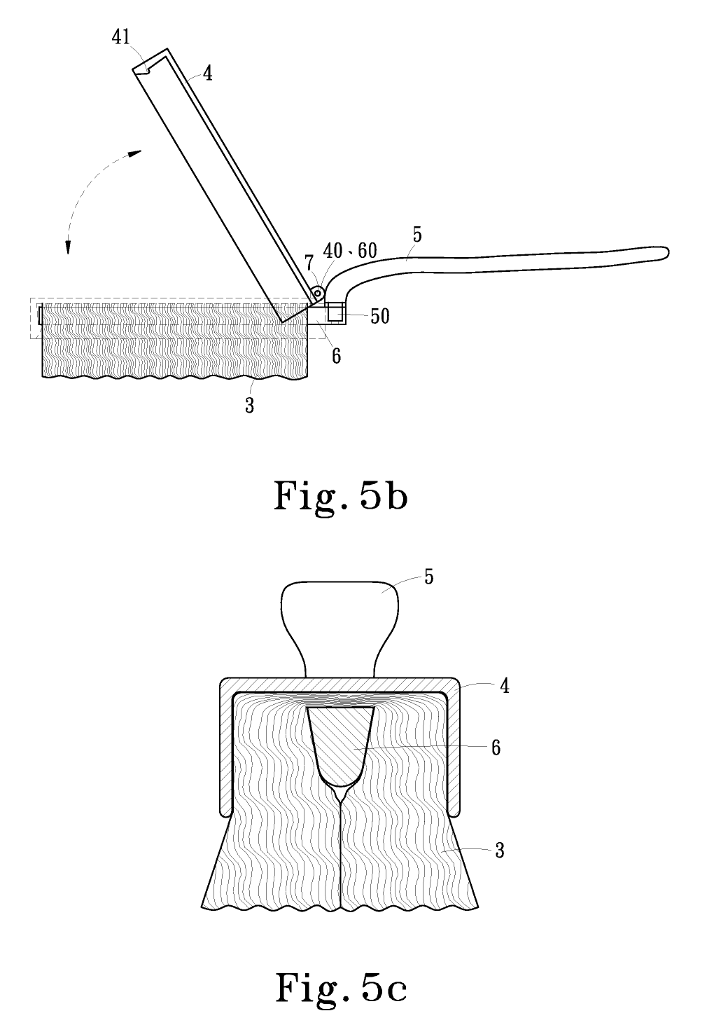

Please refer to FIGS. 2, 3, and 6. The present invention provides a dust-collecting fabric 3, which is made by overlapping plural layers of continuous filaments 30, 30′ and 30″. The layer of continuous filament 30 is oriented longitudinally, the layer of continuous filament 30′ is oriented obliquely, and the layer of continuous filament 30″ is oriented longitudinally. Then, portions of these layers of continuous filaments 30, 30′ and 30″ are connected to each other by way of resin. The fabric 3 is not subjected to a hot pressing process so as to make the finished fabric 3 fluffier. Creases are formed on the surfaces of the continuous filaments 30, 30′ and 30″ to increase the dust-collecting capacity. The continuous filaments 30, 30′ and 30″ are made of polyester (PET) fibers or polypropylene (PP) fibers to provide greater electrostatic attractive forces. The layers of continuous filaments 30, 30′ and 30″ are overlapped in a staggered manner with different orientations to thereby increase the strength and toughness of the entire structure. The thickness X of the finished dust-collecting fabric 3 is in a range between 0.5 cm and 6 cm. A single layer of the dust-collecting fabric 3 is preferably at least 0.5 cm in thickness. Alternatively, plural layers of the dust-collecting fabrics 3 can be overlapped together by welding. The basic weight of the dust-collecting fabric 3 is in a range between 60 g/m² and 300 g/m². The dust-collecting fabric 3 can be fixedly connected to another fabric 3 at suitable positions by a supersonic welding process or a thermal welding process to form welding lines 31. The welding lines 31 can increase the strength of the fabric 3. Both sides of the welding line 31 may be provided with cutouts of a suitable width. The dust-collecting fabric 3 may be provided with toothed edges 33 for collecting dust on an uneven surface. The dust-collecting fabric 3 can be folded up with respect to its center line, so that both side edges of the fabric 3 can be drawn close to each other, thereby increasing the width of the folded fabric and the strength along a vertical plane with respect to the folding line. Since the continuous filaments 30, 30′ and 30″ are overlapped in a staggered manner with different orientations and portions of the continuous filaments are connected to each other with resin, the entire structure of the fabric 3 is fluffier but with an increased strength and toughness. Thus, breakage of the continuous filaments is reduced. Furthermore, since the continuous filaments 30, 30′ and 30″ are made from PET fibers or PP fibers, greater electrostatic attractive forces can be obtained, whereby dust and hair can be collected in a more effective manner.

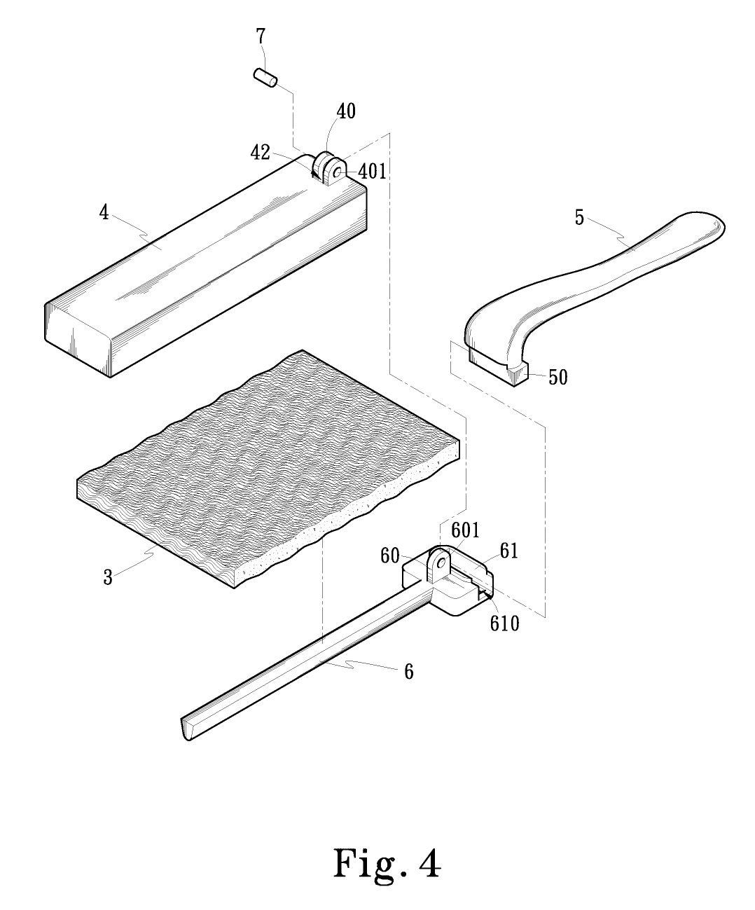

Please refer to FIG. 4. The dust-collecting fabric 3 is received in a handle comprising an upper cover 4, a grip 5 and a supporting rod 6. The upper cover 4 is formed into an inverted U shape. One end of the upper cover 4 is provided with two connecting pieces 40 each having a through-hole 401. The connecting pieces 40 are provided on both sides of a center line of the upper cover 4 in such a manner that a notch 42 is formed between the connecting pieces 40. The grip 5 is formed into a curved shape. One end of the grip 5 is formed with an engaging block 50. The supporting rod 6 is formed into a T shape, so that one end of the supporting rod 6 is formed with a rectangular body on which a trough 62 is provided. The rectangular body of the supporting rod 6 is provided with a connecting tab 60 configured for insertion into the notch 42 and a trough 61 for accepting the engaging block 50. The connecting tab 60 is provided with a hole 601. A pin 7 is disposed through the though-holes 401 of the connecting pieces 40 and the hole 601 of the connecting tab 60, whereby the upper cover 4 can be pivotally connected to the supporting rod 6. With this arrangement, the upper cover 4 can rotate with respect to the supporting rod 6 by using the pin 7 as a center of rotation. One side surface of the rectangular body is provided with an elongate post having an inverted triangular cross section. With the upper cover 4 covering the elongate post on which the dust-collecting fabric 3 straddles, the dust-collecting fabric 3 can be firmly fixed between the upper cover 4 and the supporting rod 6.

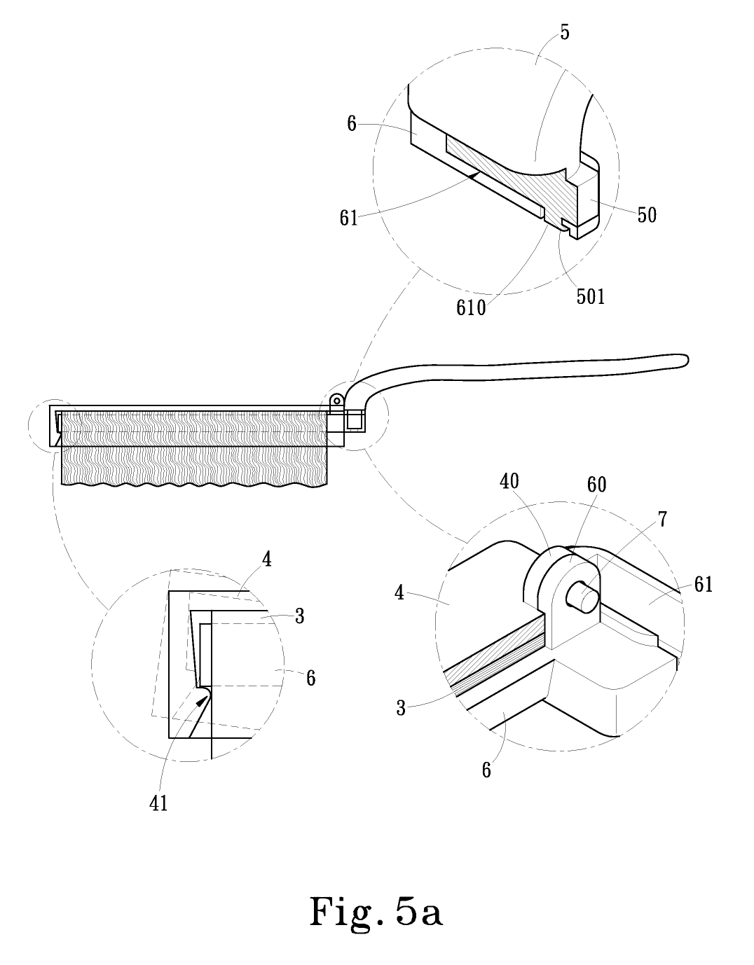

Please also refer to FIGS. 5a, 5b and 5c. In order to combine the grip 5 with the supporting rod 6, the engaging block 50 of the grip 5 slides into the trough 61 of the supporting rod 6 from one side of the rectangular body. The bottom of the engaging block 50 is provided with a locking hook 501 for engaging with a locking hole 610 on the supporting rod 6. By connecting the connecting pieces 40 of the upper cover 4 with the connecting tab 60 of the supporting rod 6 and disposing the pin 7 through the through-holes 401 and the hole 601, the upper cover 4 can be combined with the supporting rod 6. With this arrangement, the upper cover 4 can rotate with respect to the supporting rod 6 by way of the pin 7 being used as a pivot. The other end of the upper cover 4 opposite from the connecting pieces 40 is formed with a hook 41 for hooking the distal end of the elongate post of the supporting rod 6 when the upper cover 4 covers the supporting rod 6. Since the upper cover 4, the grip 5 and the supporting rod 6 are made of plastic materials using an injection molding process, they can be made with a suitable allowance for better engagement. When the upper cover 4 covers the supporting rod 6, the dust-collecting fabric 3 is sandwiched between the upper cover 4 and the supporting rod 6 to form a U shape. At this time, both side edges of the dust-collecting fabric 3 are put side by side to form a wider surface, thereby increasing its dust-collecting capacity.

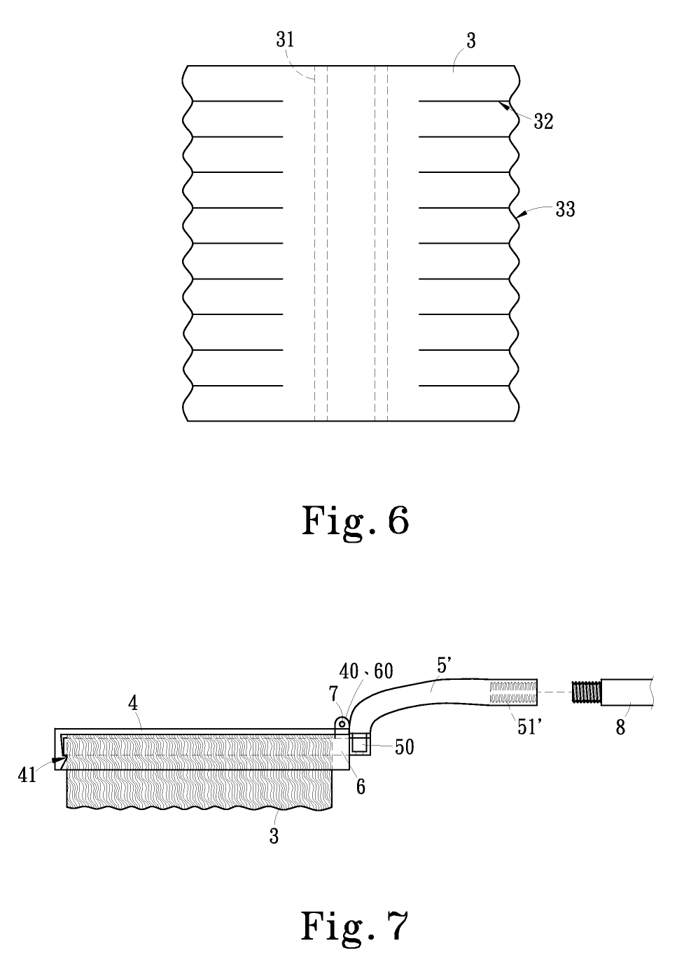

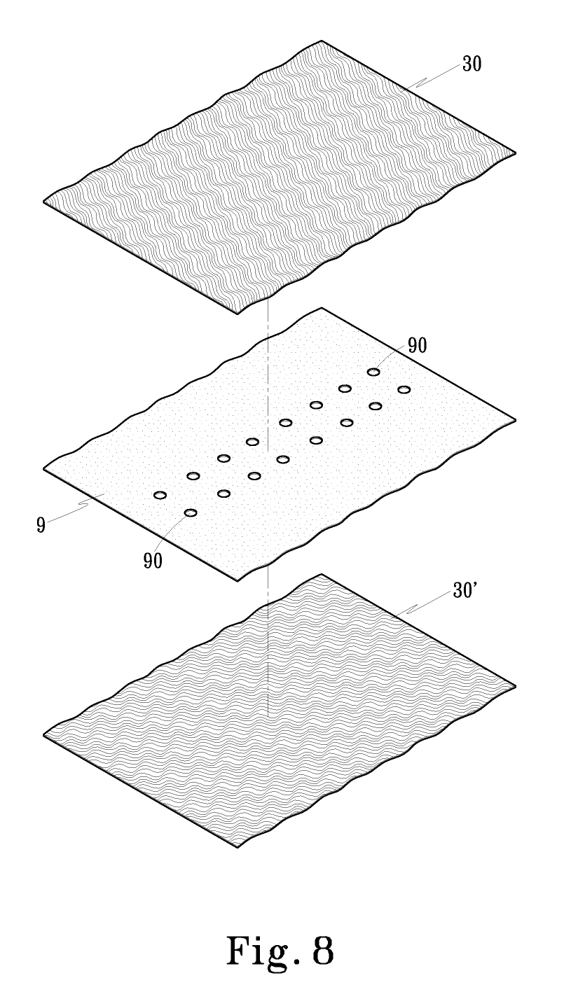

Please refer to FIGS. 7 and 8. One end of the grip 5′ is formed into a hollow pipe 51′. A connecting rod 8 is threadedly connected with the hollow pipe 51′. In this way, the user can collect dust and hair at a higher locations or in a deeper crevices. When the continuous filaments 30 and 30′ are connected to each other, an electrostatic film 9 may be additionally sandwiched there between. The center of the electrostatic film 9 is provided with a plurality of apertures 90. By performing a supersonic welding process or a thermal welding process at the positions corresponding to the apertures, the continuous filaments 30 and 30′ can be connected to each other to completely enclose the electrostatic film 9. The electrostatic film 9 is made from PET, PP or Biaxially Oriented Polypropylene (BOPP), which is capable of generating a greater electrostatic attractive forces for dusting when the electrostatic film 9 rubs against the continuous filaments 30 and 30′.

The above disclosed embodiment is merely a preferred embodiment of the present invention. Various equivalent variations and modifications may be designed as known to those skilled in the art in view of the teachings of the present invention. Thus, all such variations and equivalent modifications are also embraced within the scope of the invention as defined in the appended claims.

What is claimed is:

1. An improved structure for a dust-collecting fabric, made by overlapping plural layers of continuous filaments, characterized in that:
the plural layers of continuous filaments are overlapped longitudinally and obliquely in a staggered manner to form a dust-collecting fabric, portions of the continuous filaments are connected to each other by resin to make the dust-collecting fabric fluffier, the dust-collecting fabric is formed with teethed edges, and surfaces of the dust-collecting fabric have uneven creases.

2. The improved structure for a dust-collecting fabric according to claim 1, wherein the continuous filaments are made from polyester fibers or polypropylene fibers.

3. The improved structure for a dust-collecting fabric according to claim 1, wherein the basic weight of the dust-collecting fabric is in a range between 60 g/m² and 300 g/m².

4. The improved structure for a dust-collecting fabric according to claim 1, wherein the thickness of the dust-collecting fabric is in a range between 0.5 cm and 6 cm.

5. The improved structure for a dust-collecting fabric according to claim 1, wherein the toothed edge of the dust-collecting fabric is provided with cutouts.

6. The improved structure for a dust-collecting fabric according to claim 1, wherein one surface of the dust-collecting fabric is provided with a film having a plurality of apertures.

7. The improved structure for a dust-collecting fabric according to claim 6, wherein the film is made from polyester, polypropylene or biaxially oriented polypropylene.

8. The improved structure for a dust-collecting fabric according to claim 1, wherein the continuous filaments are connected to each other using a supersonic welding process or thermal welding process.

9. The improved structure for a dust-collecting fabric according to claim 1, wherein the resin is an acrylic resin.

10. An improved structure for a dust-collecting fabric, comprising at least one dust-collecting fabric, an upper cover, a grip and a supporting rod, characterized in that:
the upper cover is provided with two connecting pieces, the supporting rod is provided with a connecting tab and a trough, the grip is provided with an engaging block configured for engagement with the trough, a pin is disposed through the connecting pieces and the connecting tab to combine the upper cover with the supporting rod, and the dust-collecting fabric is sandwiched between the upper cover and the supporting rod to form an inverted U shape, so that both sides of the dust-collecting fabric are drawn closer to each other.

11. The improved structure for a dust-collecting fabric according to claim 10, wherein the upper cover has a hook for hooking the supporting rod.

12. The improved structure for a dust-collecting fabric according to claim 10, wherein the trough of the supporting rod has a locking hole.

13. The improved structure for a dust-collecting fabric according to claim 10, wherein the engaging block of the grip has a locking hook.

14. The improved structure for a dust-collecting fabric according to claim 10, wherein one end of the grip is in the form of a hollow pipe.
